(19) United States
(12) Patent Application Publication
(10) Pub. No.: US 2003/0217775 A1
(43) Pub. Date: Nov. 27, 2003

(54) Fluid valve

(76) Inventors: Cory Cousineau, Gladstone, MI (US); Michael P. Lasecki, Gladstone, MI (US); Mark Bader, Gladstone, MI (US); Steve Shiverski, Perronville, MI (US); Ken DeGrave, Wilson, MI (US)

Correspondence Address: BROOKS & KUSHMAN P.C., 1000 TOWN CENTER, TWENTY-SECOND FLOOR, SOUTHFIELD, MI, 48075, US

(21) Appl. No.: 10/378,119

(22) Filed: Mar. 3, 2003

Related U.S. Application Data
(60) Provisional application No. 60/360,751, filed on Mar. 1, 2002.

(51) Int. Cl. F16K 11/06

(52) U.S. Cl. 137/625.4

(57) ABSTRACT

A fluid valve having a piston for controlling fluid flow through the valve. The fluid valve includes a housing having at least one inlet and outlet. A threaded shaft within the housing connects to a joining member to move the piston with rotation of the shaft to control fluid flow.

### CROSS-REFERENCE TO RELATED APPLICATIONS

This application claims the benefit of U.S. provisional application Serial No. 60/360,751, filed Mar. 1, 2002.

### BACKGROUND OF THE INVENTION

1. Field of the Invention

The present invention relates to fluid valves having a piston to control fluid flow.

2. Background Art

Fluid control is a critical element in process control and fluid system management. Fluid control valves take many different forms including gate, ball, and flapper valves. Some valves are simply open or closed, some act to restrict flow to a desired rate, while others attempt to mix flow.

Ball and flapper-type valves are the primary configurations of current fluid valves. But, each has their strengths and weaknesses. Ball valves can be very precise in controlling flow, however, because of the close tolerances required for smooth operation, the ball and housing can be very expensive. There is considerable friction between the ball and housing and this requires the motor to be much larger. Also, high flows will cause the ball to be self-closing in certain positions which dictates that the drive mechanism be designed to be self-locking. Both of these factors lead to high costs.

Flapper valves can mix flows, but have inherent flaws. For example, they are not self locking (to an even worse degree than ball valves) which again leads to expensive motor/drive mechanisms. Moreover, the flapper and pivot inflict a high restriction on the flow, even when the flapper is positioned so that 100% of the flow is directed towards one outlet. As such, there exists a need for a fluid valve that overcomes the above-identified deficiencies of known fluid valves.

### SUMMARY OF THE INVENTION

The present invention relates to a fluid valve having a piston to control fluid flow. The valve can include any number of inputs and outputs. Moreover, the valve can position the piston to proportion flow from the inlets to the outlets and prevent flow from one or more of the inlets to the outlets.

One aspect of the present invention relates to a fluid valve for controlling fluid flow. The fluid flow comprises a housing having a first inlet, an outlet, and a fluid flow passageway from the at least one inlet to the outlet. A piston is positioned in fluid communication with the fluid flow passageway for controlling fluid flow through the passageway. A joining member connects to the piston and a rotatable threaded shaft in the passageway to control fluid flow. Rotation of the shaft affects the joining member for moving the piston to control fluid flow through the fluid flow passageway.

Another aspect of the present invention relates to a fluid valve for use with an engine to control coolant flow to the engine from a bypass and a radiator. The fluid valve comprises a housing having a first inlet to receive coolant from the bypass, a second inlet to receive coolant from the radiator, an outlet to direct the received coolant to the engine, and a fluid flow passageway connecting the inlets to the outlet. A piston is positioned in fluid communication with the fluid flow passageway for proportioning coolant flow from the bypass and the radiator to the engine. The piston is positionable within the fluid flow passageway to: (i) proportion coolant flow from the bypass and the radiator to the engine, (ii) permit coolant flow from only the radiator to the engine, and (iii) permit coolant flow from only the bypass to the engine. A joining member is connected to the piston and a threaded shaft for moving the piston in the fluid flow passageway to control coolant flow to the engine. Rotation of the shaft affects the joining member for moving the piston to control coolant flow through the fluid flow passageway.

Another aspect of the present invention relates to an electronic fluid valve for proportioning and/or mixing fluid. The electronic fluid valve comprises a housing having more than one inlet path and one outlet path for proportioning and/or mixing a fluid entering from one or more inlet paths into the outlet path. A piston is located in a mixing portion of an internal passageway of the housing to direct the fluid from the inlet paths to the outlet path. The piston is secured to a threaded shaft nut. The piston includes at least one flat surface or similar feature on an outer perimeter to prevent rotation, yet allow linear translation within the housing. A motor shaft is included for threadably engaging with the threaded shaft nut end rotating to cause movement of the shaft nut along the motor shaft to slidably position the piston between the nut paths to proportion and/or mix the fluid entering from one or more inlet paths into an outlet path. An electronic motor is positioned within the housing and responsive to electronic control signals for supporting and rotating the motor shaft. In addition, the housing can include an alternative configuration having one inlet path and more than one outlet path for proportioning and/or mixing a fluid entering from the inlet path into one or more of the outlet paths.

Another aspect of the present invention relates to an electronic fluid valve for proportioning and/or mixing fluid. The electronic fluid valve comprises a housing having more than one inlet path and one outlet path for proportioning and/or mixing a fluid entering from one or more of the inlet paths into the outlet path. A piston is located in a mixing portion of an internal passageway of the housing to direct the fluid from one or more of the inlet paths into the outlet path. The piston is secured at one end to a pivot of the housing and pivotally secured at another end to a linkage connected to a threaded shaft nut. A motor shaft is threadably engaged with the threaded shaft nut and rotatable for positioning the threaded shaft nut along the motor shaft. The linkage provided actuates the gate about the pivot and between the inlet paths to mix the fluid entering from one or more of the inlet paths into the outlet path. An electronic motor is positioned within the housing and responsive to electronic control signals for supporting and rotating the motor shaft. In addition, the housing can include an alternative configuration having one inlet path and one outlet path for proportioning a fluid entering from the inlet path to the outlet path.

Another aspect of the present invention relates to an electronic fluid proportioning valve for proportioning fluid. The electronic fluid proportioning valve comprises a housing having one inlet path and one outlet path for proportioning a fluid entering from the inlet path to the outlet path. A piston is located in a proportioning portion of an internal passageway of the housing to direct the fluid from the inlet path to the outlet path. The piston is secured to a threaded shaft nut and includes at least one flat surface or similar feature on an outer perimeter to prevent rotation, yet still allow linear translation within the housing. A motor shaft threadably engages the shaft nut and rotates for actuating movement of the threaded shaft nut along the motor shaft. The piston is slidably positioned between the inlet path and the outlet path to proportion the fluid entering from the inlet path into the outlet path. The electronic motor is positioned within the housing responsive to electronic control signals for supporting and rotating the motor shaft.

### BRIEF DESCRIPTION OF THE DRAWINGS

FIG. 1 illustrates a fluid valve having a piston to control fluid flow in accordance with the present invention;

FIG. 2 illustrates control of fluid flow through the valve;

FIG. 3 illustrates further control of the fluid flow through the valve;

FIG. 4 illustrates a cross-section of the valve illustrating one anti-rotation feature in accordance with the present invention;

FIG. 5 illustrates another anti-rotation feature in accordance with the present invention;

FIG. 6 illustrates yet another anti-rotation feature in accordance with the present invention;

FIG. 7 illustrates another fluid valve for controlling fluid flow in accordance with the present invention;

FIG. 8 illustrates yet another fluid valve for controlling fluid flow in accordance with the present invention; and

FIG. 9 illustrates still another fluid valve for controlling fluid flow in accordance with the present invention.

### DETAILED DESCRIPTION OF THE DRAWINGS

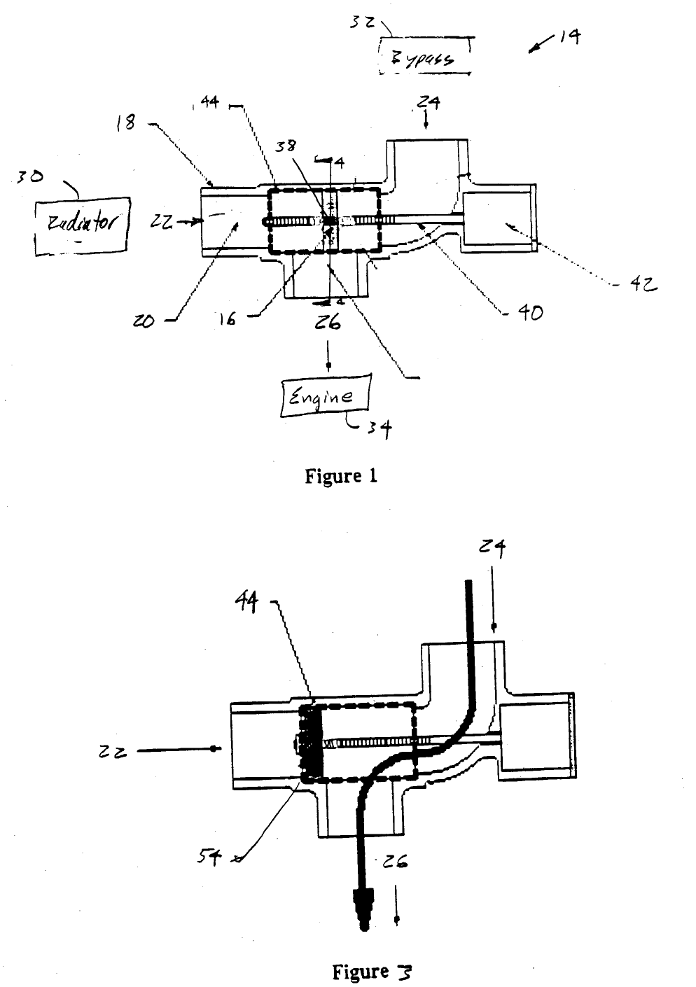

FIG. 1 illustrates an electronic fluid valve 14 in accordance with the present invention. The valve 14 includes a piston 16 to control fluid flowing through the valve 14. More specifically, the piston 16 is slidably movable within the valve 14 to mix and proportion the fluid flow. The valve 14 is operative for industrial and automotive environments, amongst others. The description provided herein relates to an automotive embodiment of the present invention and is not intended to limit the scope of the present invention to automotive environments.

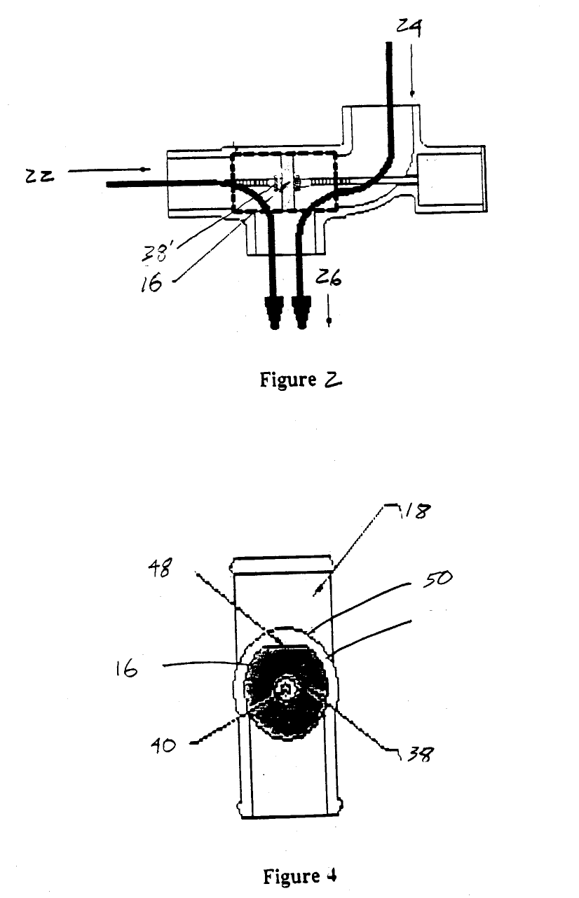

The valve 14 includes a housing 18 with an internal fluid flow passageway 20 connecting two inlets 22, 24 to outlet 26, however, the valve 14 is operative to control fluid flow with any number and combination of inlets and outlets. The inlet 22 receives cooled coolant fluid from a radiator 30, the inlet 24 receives coolant from a radiator bypass 32, and the outlet 26 delivers the coolant to an engine 34. The piston 16 is slidable within passageway 20 to direct fluid from inlets 22, 24 to the outlet 26. FIG. 2 illustrates coolant flow is controllable to permit simultaneously proportioning fluid flow from the inlets 22, 24 to the outlet 26, and FIG. 3 illustrates coolant flow is controllable to permit fluid flow from only one of the inlets 22, 24 to outlet 26.

The piston 16 is connected to a joining member 38. In FIG. 1, the joining member 38 is formed integral within the piston 16 as a tap for threadable securement to a threaded shaft 40. In FIG. 2, the joining member 38′ is a shaft nut. The threaded shaft 40 engages the threaded joining member 58 such that turning of the shaft 40 causes the joining member to walk or translate along the shaft 40 threads. In this manner, the piston 16 is longitudinally translatable along the shaft 40 with rotation of the shaft 40 to position the piston 16 to control fluid flow.

An electronic motor 42, encased within the housing 18 and responsive to electronic signals, supports and rotates the shaft 40. The shaft 40 and joining member 38 can include self-locking threads to lock the piston 16 in position without requiring any torque to be applied to the shaft 40 from the motor 42 such that the motor can save power. The shaft 40 can include bellow 43 to protect the threads from the coolant. The bellow 45 can seal at one end to joining member 38 and at another end to housing 18 to seal the threads from the coolant.

In general, passageway 20 includes a mixing portion 44 where the piston 16 moves between inlet 22, inlet 24 and outlet 26 to mix and proportion fluid flow. Mixing portion 44 can include any length and width. Typically, at least the mixing portion 44 of the passageway 20 is generally cylindrical, but it can be any other shape, such as rectangular, hexagonal, and others.

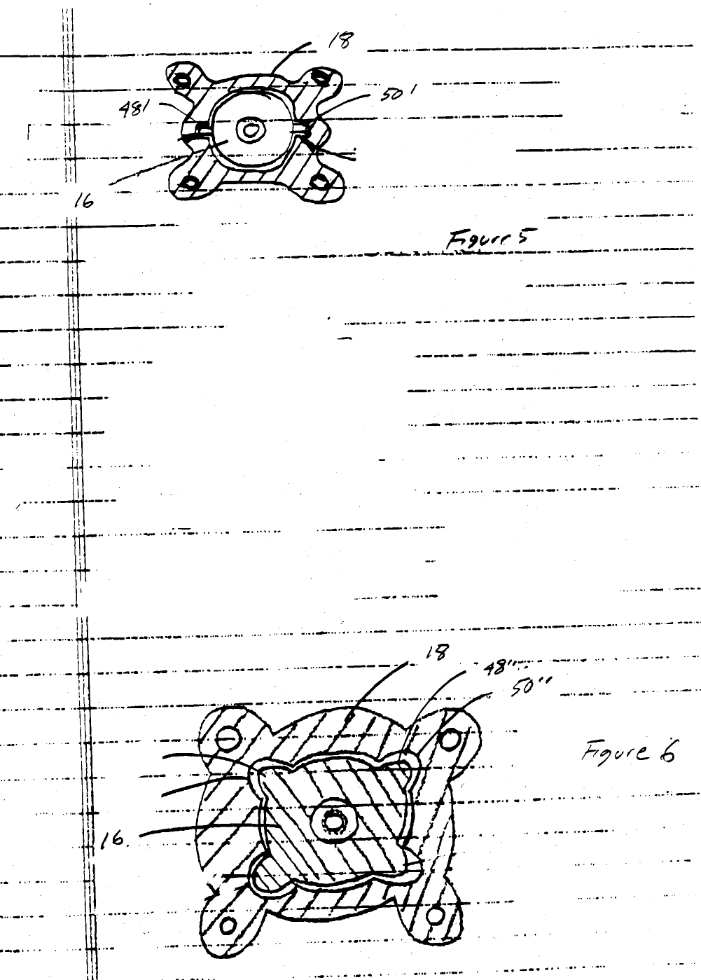

The piston 16 includes an anti-rotation element 48 and the passageway 20, at least in the mixing portion 44, includes an anti-rotation element 50. The anti-rotation elements permit the joining member 38 to translate along shaft 40 with shaft rotation. In FIG. 4, one of the number of anti-rotation elements is shown. Both the piston element 48 and the passageway element 50 include at least one flat surface or similar feature to prevent the rotation of piston 16 and still allow linear translation within passageway 20. The flat 48 of the piston 16 is a channel recessed relative to the generally cylindrical portion of the piston 16, and the flat 50 of the passageway 20 is a protuberance extending relative to the generally cylindrical mixing portion 44.

The anti-rotation features engage each other to prevent the piston 16 from rotating. The anti-rotation features can include any number of recesses or protuberances for either or both of the piston 16 and the housing 18 that would prevent the piston 16 from rotating with rotation of the shaft 40. Moreover, while not shown, the piston 16 and the housing 18 can include additional features and components. For example, the piston 16 can include a nut or other feature connecting to the shaft 40 to prevent the piston 16 from rotating. In this case, only one anti-rotation feature can be used so that the piston 16 and housing 18 do not both have to include an anti-rotation feature.

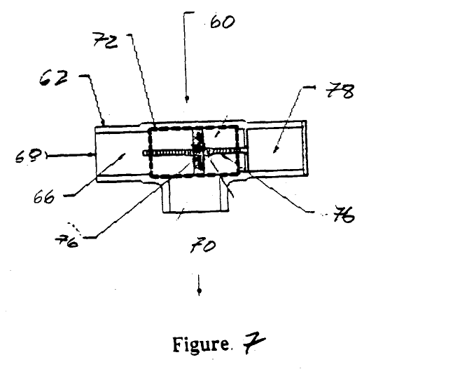

FIGS. 5 and 6 illustrates additional arrangements for the anti-rotation features. In FIG. 5, the piston 16 includes two protuberant flats 48′ extending relative to the piston 16, and the housing 18 includes two corresponding recessed channels 50′ to engage the flats 48′ to prevent the piston 16 from rotating. In FIG. 6, the piston 16 includes four protuberant lobes 48″ extending relative to the piston 16, and the housing 18 includes two corresponding recessed channels 50″ to engage the lobes 48″ to prevent the piston 16 from rotating.

FIG. 3 illustrates piston 16 positioned at an extreme edge of mixing portion 44. In this position, piston 16 prevents coolant flow from radiator 30 from flowing to engine 34. As such, the coolant flows only from inlet 24 through mixing chamber 44 to outlet 26. A sealing portion 54 of the mixing portion 44 is sufficiently sized relative to the piston 16 such that the piston 16 can completely cover the sealing portion 54 and seal off the inlet 22. This arrangement is typically advantageous to ensure all coolant fluid is recycled through the bypass 32 to the engine 34, such that the coolant temperature can rise as fast as possible during cold starts.

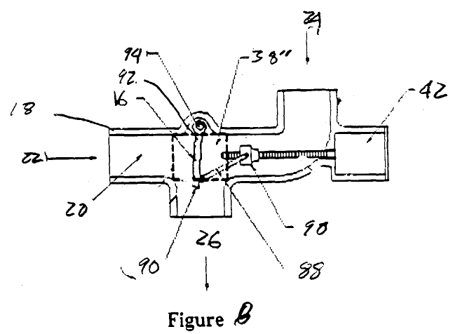

FIG. 7 illustrates a fluid valve 60 in accordance with yet another aspect of the invention. Fluid valve 60 includes a housing 62 with an internal passageway 66 connecting one inlet 68 to one outlet 70. Passageway 66 directs fluid from inlet 68 to outlet 70 and includes a proportioning portion 72 where a piston 76 is located to proportion fluid from inlet 68 into outlet 70. The piston 76 includes anti-rotation features similar to those described above to permit longitudinal translation of the piston 76 along a threaded shaft 76 turned by motor 78.

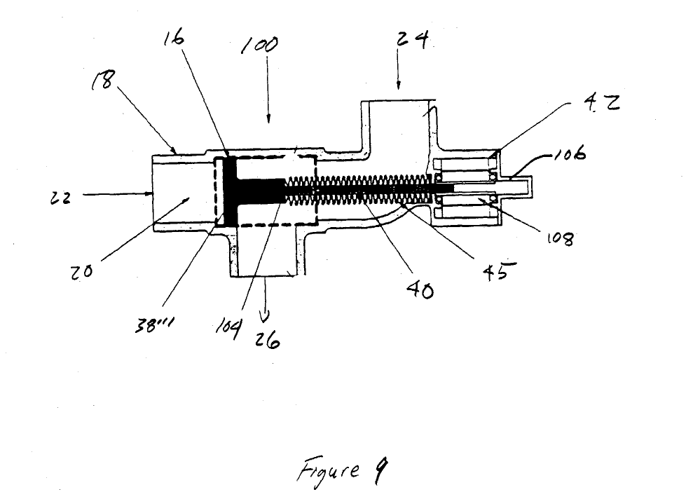

FIG. 8 illustrates a fluid valve 84 in accordance with still yet another aspect of the invention. Fluid valve 84 includes a piston 16, as described above, to proportion fluid flow from inlets 22, 24 to outlet 26. The joining member 38″ includes a linkage 88 connected at a first portion 90 to the shaft 40 and affixed at a second portion 92 to the passageway 20. Portion 92 includes a pivotable assembly 94. With shaft 40 rotation, joining member 38″ and the linkage 88 translate along shaft 40 to flap the piston relative to the housing 18 to control fluid flow.

FIG. 9 illustrates a fluid valve 100 in accordance with still yet another embodiment of the present invention. In this embodiment, fluid flows in from inlets 22, 24 through a mixing portion 44, and flows through outlet 26. Advantageously, the piston 16 includes a joining member 38′″ connected to an end 104 of threaded shaft 40. The joining member 38′″ can be a fastener or other adhesive on piston 16 for securement to shaft 40. Rather than the piston 16 moving along the threaded shaft 40, the piston 16 is permanently affixed to the end of the shaft 40 and the shaft 40 moves to move the piston 16 for controlling fluid flow.

A threaded portion 106 of the shaft 40 extends into the motor 42. The motor 42 includes a similarly threaded rotor portion 108 to receive the threaded shaft 40. Rotor portion 108 rotates by electrical impulses to translate the shaft 40 therealong to move the piston 16 to control fluid flow. The electric motor 42 and shaft 40 are sealed from the fluid with bellows 45.

Electric motor 42 is electrically powered and controlled, and can include a computer storage medium that maintains computer language for programming the motor 42. Motor 42 can receive electronic signals from an electronic control unit (not shown). Piston 16 positions, fluid flow rates, fluid temperatures, and a number of other parameters relevant to fluid systems, can be tracked by a control unit and incorporated to operate piston 16 in a desired fashion for proportioning and/or mixing the fluid.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An fluid valve comprising:
a housing having at least one inlet, an outlet, and a fluid flow passageway from the at least one inlet to the outlet;
a piston positioned in fluid communication with the fluid flow passageway for controlling fluid flow through the passageway;
a rotatable threaded shaft in the passageway to control fluid flow; and
a joining member connected to the piston and the shaft, wherein rotation of the shaft affects the joining member for moving the piston to control fluid flow through the fluid flow passageway.

2. The fluid valve of claim 1 wherein the joining member is a tapped portion formed within the piston to threadably engage the shaft, wherein rotation of the shaft threadably translates the piston along the shaft to control fluid flow through the fluid flow passageway.

3. The fluid valve of claim 1 wherein the piston further comprises an anti-rotation element, wherein the anti-rotation element prevents the piston from rotating relative to rotation of the shaft to permit the piston to translate along the shaft with rotation of the shaft to control fluid flow through the fluid flow passageway.

4. The fluid valve of claim 3 wherein the fluid flow passageway is generally cylindrical and includes a channel recessed relative to the generally cylindrical passageway, and wherein the anti-rotation element is a protuberance extending beyond a generally cylindrical portion of the piston and configured to engage the channel to prevent rotation of the piston relative to the channel such that the piston translates along the shaft with rotation of the shaft to control fluid flow through the fluid flow passageway.

5. The fluid valve of claim 3 wherein the fluid flow passageway is generally cylindrical and includes a protuberance extending relative to the generally cylindrical passageway, and wherein the anti-rotation element is a channel recessed relative to a generally cylindrical portion of the piston to engage the protuberance to prevent rotation of the piston relative to the protuberance such that the piston translates along the shaft with rotation of the shaft to control fluid flow through the fluid flow passageway.

6. The fluid valve of claim 1 wherein at least one of the at least one inlets includes a sealing portion have an opening sufficiently sized relative to the piston such that the piston can completely cover and seal off the inlet having the sealing portion to prevent fluid flow from the sealed inlet to the outlet.

7. The fluid valve of claim 1 wherein the joining member is a linkage connected to a first portion of the piston and to the threaded shaft, wherein the piston further comprises a second portion connected to the fluid flow passageway such that rotation of the shaft threadably translates the linkage along the shaft to flap the piston relative to the second portion of the piston connected to the passageway to control fluid flow through the fluid flow passageway.

8. The fluid valve of claim 1 wherein the joining member is permanently connected to the piston and a first end of the threaded shaft, and wherein the valve further comprises a motor having a threaded rotor to engage a second end of the shaft such that the rotor turns to threadably translate the shaft along the rotor to move the piston connected to the first end of the shaft to control fluid flow through the fluid passageway.

9. The fluid valve of claim 1 further comprising a bellow encasing the threaded shaft, wherein the bellow is sealed at a first end to the joining member and sealed at a second end to the fluid flow passageway to protect the threads from contamination and debris.

10. A fluid valve for use with an engine to control coolant flow to the engine from a bypass and a radiator, the fluid valve comprising:
a housing having a first inlet to receive coolant from the bypass, a second inlet to receive coolant from the radiator, an outlet to direct the received coolant to the engine, and a fluid flow passageway connecting the inlets to the outlet;
a piston positioned in fluid communication with the fluid flow passageway for proportioning coolant flow from the bypass and the radiator to the engine, wherein the piston is positionable within the fluid flow passageway to: (i) proportion coolant flow from both the bypass and the radiator to the engine, (ii) permit coolant flow from only the radiator to the engine, and (iii) permit coolant flow from only the bypass to the engine;
a rotatable threaded shaft for moving the piston in the fluid flow passageway to control coolant flow to the engine; and
a joining member connected to the piston and the threaded shaft, wherein rotation of the shaft affects the joining member for moving the piston to control coolant flow through the fluid flow passageway.

11. The fluid valve of claim 10 wherein the joining member is a tapped portion formed within the piston to threadably engage the shaft, wherein rotation of the shaft threadably translates the piston along the shaft to control coolant flow through the fluid flow passageway.

12. The fluid valve of claim 10 wherein the piston further comprises an anti-rotation element, wherein the anti-rotation element prevents the piston from rotating relative to rotation of the shaft to permit the piston to translate along the shaft with rotation of the shaft to control fluid flow through the fluid flow passageway.

13. The fluid valve of claim 12 wherein the fluid flow passageway is generally cylindrical and includes a channel recessed relative to the generally cylindrical passageway, and wherein the anti-rotation element is a protuberance extending beyond a generally cylindrical portion of the piston to engage the channel to prevent rotation of the piston relative to the channel such that the piston translates along the shaft with rotation of the shaft to control fluid flow through the fluid flow passageway.

14. The fluid valve of claim 12 wherein the fluid flow passageway is generally cylindrical and includes a protuberance extending relative to the generally cylindrical passageway, and wherein the anti-rotation element is a channel recessed relative to a generally cylindrical portion of the piston to engage the protuberance to prevent rotation of the piston relative to the protuberance such that the piston translates along the shaft with rotation of the shaft to control fluid flow through the fluid flow passageway.

15. The fluid valve of claim 10 wherein the second inlet receiving coolant flow from the radiator includes a sealing portion have an opening sufficiently sized relative to the piston such that the piston can completely cover and seal off coolant flow from the radiator.

16. The fluid valve of claim 10 wherein the joining member is a linkage connected to a first portion of the piston and to the threaded shaft, wherein the piston further comprises a second portion connected to the fluid flow passageway such that rotation of the shaft threadably translates the linkage along the shaft to flap the piston relative to the second portion of the piston connected to the passageway to control coolant flow through the fluid flow passageway.

17. The fluid valve of claim 10 wherein the joining member is permanently connected to the piston and a first end of the threaded shaft, and wherein the valve further comprises a motor having a threaded rotor to engage a second end of the shaft such that the rotor turns to threadably translate the shaft along the rotor to move the piston connected to the first end of the shaft to control coolant flow through the fluid passageway.

18. The fluid valve of claim 10 further comprising a bellow encasing the threaded shaft, wherein the bellow is sealed at a first end to the joining member and sealed at a second end to the fluid flow passageway to protect the threads from the coolant.

19. An electronic fluid valve for proportioning and/or mixing fluid, the electronic fluid valve comprising:
a housing having more than one inlet path and one outlet path for proportioning and/or mixing a fluid entering from one or more inlet paths into the outlet path;
a piston located in a mixing portion of an internal passageway of the housing to direct the fluid from the inlet paths to the outlet path, the piston being secured to a threaded shaft nut, the piston includes at least one flat surface or similar feature on an outer perimeter to prevent rotation, yet still allow linear translation within the housing;
a motor shaft threadably engaged with the threaded shaft nut and rotatable for actuating movement of the threaded shaft nut along the motor shaft, whereby the piston is slidably positioned between the inlet paths to proportion and/or mix the fluid entering from one or more inlet paths into the outlet path; and
an electronic motor positioned within the housing and responsive to electronic control signals for supporting and rotating the motor shaft.

20. An electronic fluid valve for proportioning and/or mixing fluid, the electronic fluid valve comprising:
a housing having one inlet path and more than one outlet path for proportioning and/or mixing a fluid entering from the inlet path into one or more of the outlet paths;
a piston located in a mixing portion of an internal passageway to direct the fluid from the inlet path to one or more of the outlet paths, the piston being secured to a threaded shaft nut; the piston includes at least one flat surface or similar feature on an outer perimeter to prevent rotation, yet still allow linear translation within the housing;
a motor shaft threadably engaged with the threaded shaft nut and rotatable for actuating movement of the threaded shaft nut along the motor shaft, whereby the piston is slidably positioned between the outlet paths to proportion and/or mix the fluid entering from the inlet path into one or more outlet paths; and
an electronic motor positioned within the housing and responsive to electronic control signals for supporting and rotating the motor shaft.

21. An electronic fluid valve for proportioning and/or mixing fluid, the electronic fluid valve comprising:
a housing having more than one inlet path and one outlet path for proportioning and/or mixing a fluid entering from one or more of the inlet paths into the outlet paths;
a piston located in a mixing portion of an internal passageway of the housing to direct the fluid from one or more of the inlet paths into the outlet path, the piston being secured at one end to a pivot of the housing and pivotally secured at another end to a linkage connected to a threaded shaft nut;
a motor shaft threadably engaged with the threaded shaft nut and rotatable for positioning the threaded shaft nut along the motor shaft, whereby the linkage pivotally actuates the gage about the pivot and between the inlet paths to mix the fluid entering from one or more of the inlet paths into the outlet path; and
an electronic motor positioned within the housing and responsive to electronic control signals for supporting and rotating the motor shaft.

22. An electronic fluid proportioning valve for proportioning fluid, the electronic fluid proportioning valve comprising:
a housing having one inlet path and one outlet path for proportioning a fluid entering from the inlet path into the outlet path;
a piston located in a proportioning portion of an internal passageway of the housing to direct the fluid from the inlet path to the outlet path, the piston being secured to a threaded shaft nut; the piston includes at least one flat surface or similar feature on an outer perimeter to prevent rotation, yet still allow linear translation within the housing;
a motor shaft threadably engaged with the shaft nut and rotatable for actuating movement of the threaded shaft nut along the motor shaft, whereby the piston is slidably positioned between the inlet path and the outlet path to proportion the fluid entering from the inlet path into the outlet path; and
an electronic motor positioned within the housing and responsive to electronic control signals for supporting and rotating the motor shaft.
